(19) United States
(12) Patent Application Publication
(10) Pub. No.: US 2009/0033879 A1
(43) Pub. Date: Feb. 5, 2009

(54) PROJECTOR APPARATUS AND CONTROL METHOD FOR PROJECTOR APPARATUS

(75) Inventor: Kimiaki Saito, Ome-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/173,699

(22) Filed: Jul. 15, 2008

(30) Foreign Application Priority Data
Jul. 31, 2007 (JP) 2007-199396

(51) Int. Cl. G03B 21/16

(52) U.S. Cl. 353/52; 353/85

(57) ABSTRACT

According to one embodiment, a projector apparatus comprises an input detector configured to detect input of an image signal, a light source, a modulator configured to modulate light emitted from the light source, a cooling unit configured to cool the light source and the modulator, a power controller configured to control a driving power of the light source in accordance with a result of detection of the image signal by the input detector, and a projecting unit configured to project the light modulated by the modulator.

### CROSS-REFERENCE TO RELATED APPLICATIONS

This application is based upon and claims the benefit of priority from Japanese Patent Application No. 2007-199396, filed Jul. 31, 2007, the entire contents of which are incorporated herein by reference.

### BACKGROUND

1. Field

One embodiment of the present invention relates to a projector apparatus in which deterioration of optical components can be suppressed and a control method for the projector apparatus.

2. Description of the Related Art

A projector apparatus is a display device which displays image information on a large screen. With recent advances in imaging techniques, there have been increases in the brightness of a lamp used as a light source for the projector apparatus. As the lamp emits light with high brightness and generates heat, a rise in temperature occurs. This makes it necessary to cool the lamp by using a cooling fan.

In the conventional projector apparatus, when no input signal is detected, the brightness of the lamp is decreased to suppress unnecessary power consumption. Such a projector apparatus decreases a rotational speed of the cooling fan with a decrease in lamp brightness, thereby reducing power consumption and noise generated by the cooling fan. For example, a liquid crystal projector apparatus disclosed in Jpn. Pat. Appln. KOKAI Publication No. 2003-5147 decreases lamp brightness and a rotational speed of a cooling fan when there is no input image signal. In addition, a projector including an optical disk reproducing apparatus, which is disclosed in Jpn. Pat. Appln. KOKAI Publication No. 2006-243551, decreases lamp brightness and a rotational speed of a fan when no optical disk is loaded in the optical disk reproducing apparatus.

However, organic materials are used for optical components of a projector apparatus, and hence the optical components other than the lamp may deteriorate due to a rise in temperature. Even when the lamp is cooled by the cooling fan, optical components other than the lamp may not be sufficiently cooled. In addition, because the rotational speed of the cooling fan is decreased and the cooling capacity is reduced when no image signal is input, a sufficient cooling effect cannot be obtained and the lifetimes of the optical components may not be sufficiently prolonged.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram showing an electric configuration of a projector apparatus according to a first embodiment of the invention;

FIG. 2 is an exemplary view schematically showing a three-LCD optical engine;

FIG. 3 is an exemplary flowchart showing processing according to the first embodiment of the projector apparatus;

FIG. 4 is an exemplary block diagram showing an electric configuration of a projector apparatus according to a second embodiment of the invention; and

FIG. 5 is an exemplary flowchart showing processing according to the second embodiment of the projector apparatus.

### DETAILED DESCRIPTION

Various embodiments according to the invention will be described hereinafter with reference to the accompanying drawings. In general, according to one embodiment of the invention, a projector apparatus comprises an input detector configured to detect input of an image signal, a light source, a modulator configured to modulate light emitted from the light source, a cooling unit configured to cool the light source and the modulator, a power controller configured to control a driving power of the light source in accordance with a result of detection of the image signal by the input detector, and a projecting unit configured to project the light modulated by the modulator.

The embodiments of the projector apparatus of the present invention will be described with reference to the accompanying drawing.

### FIRST EMBODIMENT

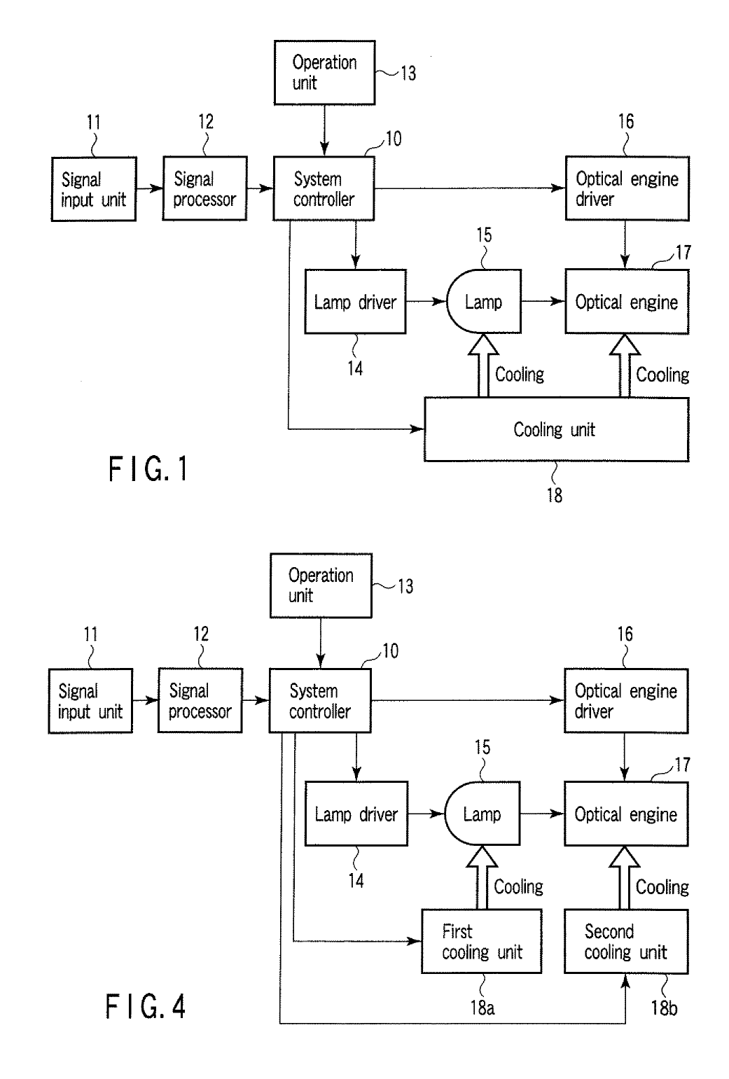

FIG. 1 is an exemplary block diagram showing an electric configuration of the projector apparatus according to the first embodiment of the invention.

A system controller 10 includes a CPU and storage such as a ROM or RAM (not shown). The system controller 10 controls operations of components of the projector apparatus in accordance with control programs stored in the storage.

A signal input unit 11 includes image signal input terminals for plural input lines including an S-video terminal, a DVI-I terminal, and a D-sub terminal. The signal input unit 11 receives image signals such as an RGB signal, a video signal, an image signal from a personal computer (PC), and an image signal from an optical disk device such as a DVD, via the above image signal input terminals. An image signal input to the signal input unit 11 is sent to a signal processor 12. The signal processor 12 performs predetermined signal processing on the input image signal, and converts the signal into an image signal having a format corresponding to display elements of an optical engine 17.

An operation unit 13 includes a power button and various kinds of function buttons. A user operates the operation unit 13 to select a specific input line through which the image signal to be projected on a screen is input.

A lamp driver 14 includes a lamp power circuit for driving a lamp 15. The lamp driver 14 drives the lamp 15 under the control of the system controller 10. The lamp 15 emits light and applies the light to the optical engine 17. The lamp 15 includes an ultra-high pressure mercury lamp, for example.

An optical engine driver 16 drives the optical engine 17 under the control of the system controller 10. The optical engine 17 modulates the light emitted from the lamp 15 and projects the light onto the screen.

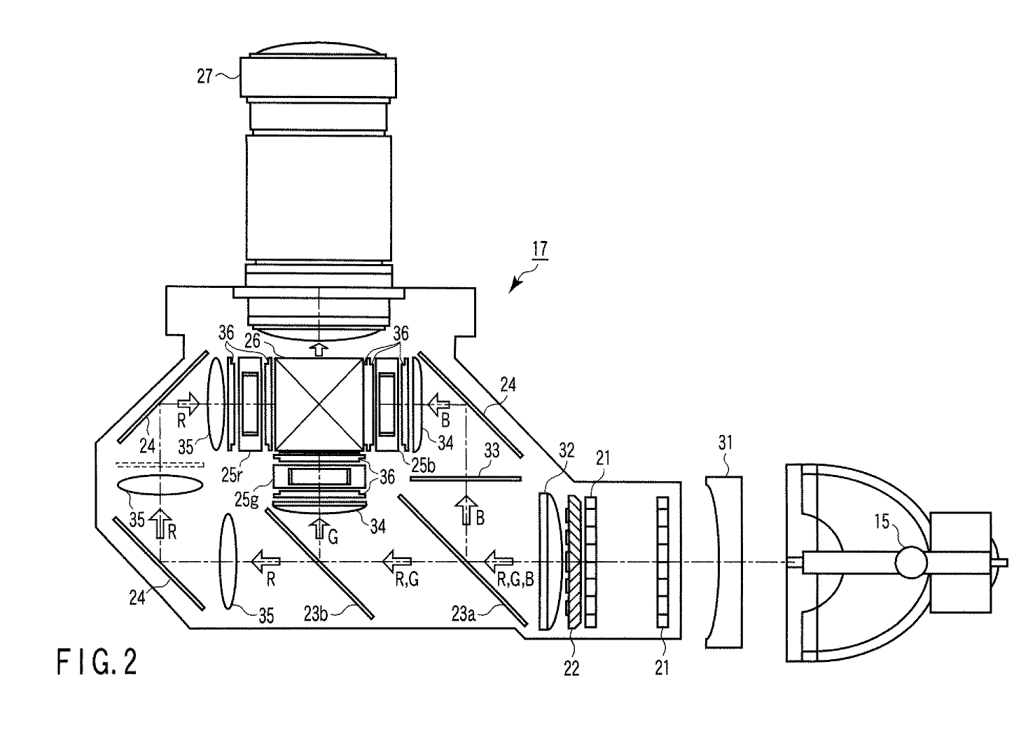

FIG. 2 is an exemplary view schematically showing an optical engine 17 of a three-LCD system. Three liquid crystal panels are used in the three-LCD system projector apparatus.

Light radiating from the lamp 15 strikes the optical engine 17 through a concave lens 31. The light incoming to the optical engine 17 is uniformed by a multi-lenses (integrator lens) 21. A polarization beam splitter (PBS) 22 functions as a polarization converter. Polarization axes of polarization-converted light beams are aligned in one direction in accordance with the driving of the liquid crystal panels. The polarization-converted light is collected by a condenser lens 32. Dichroic mirrors 23a and 23b separate the light into three colors of light, i.e., red (R), green (G), and blue (B). The separated R, G, and B light beams are reflected by total reflection mirrors 24, pass through field lenses 34 and relay lenses 35, and strike the corresponding liquid crystal panels of the respective colors. The red (R), green (G), and blue (B) light respectively strike liquid crystal panels 25r, 25g, and 25b. The optical engine driver 16 controls the transmittances and reflectances of the light beams striking the liquid crystal panels 25r, 25g, and 25b. Polarizing plates 36 are provided before and after the liquid crystal panels 25r, 25g, and 25b. A dichroic prism 26 combines the separated R, G, and B light beams again. A projection lens 27 projects the resultant light onto the screen.

The signal input unit 11 has a function of detecting whether an image signal is input to an image signal input terminal. When no image signal is input to any image signal input terminal, the system controller 10 reads out a predetermined background image (e.g., a blue screen) stored in advance in the storage such as the ROM, and projects the background image onto the screen with the lamp 15 through the optical engine 17.

Even in the case where an image signal is input to the signal input unit 11, when the image signal is not from a selected input line which is previously selected by a user, the system controller 10 reads out the predetermined background image from the storage and projects the background image onto the screen with the lamp 15 through the optical engine 17.

The optical engine 17 includes optical components such as liquid crystal panels and polarizing plates which are made of organic materials. These optical components deteriorate due to a rise in temperature. In order to suppress the rise in temperature due to the light emission of the lamp 15, a cooling unit 18 cools the lamp 15 and the optical engine 17. The cooling unit 18 includes a cooling fan and a duct. The system controller 10 can adjust the cooling capacity of the cooling unit 18 by controlling a rotational speed of the cooling fan.

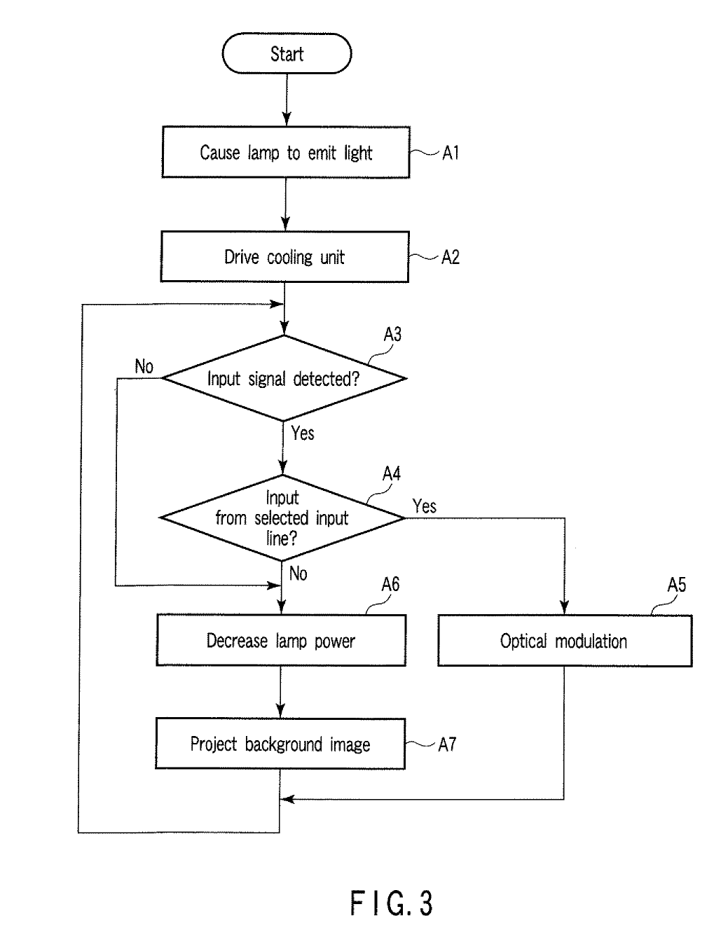

The operation of the projector apparatus having the above configuration according to the first embodiment will be described next. FIG. 3 is an exemplary flowchart showing processing according to the first embodiment of the projector apparatus.

When the projector apparatus starts up, the system controller 10 controls the lamp driver 14 to cause the lamp 15 to start light emission with predetermined brightness (block A1). The lamp 15 emits light with brightness which is appropriate to image projection. The cooling unit 18 drives the cooling fan at a predetermined rotational speed and starts cooling the lamp 15 and the optical engine 17 (block A2). The cooling capacity of the cooling unit 18 (rotational speed of the cooling fan) is set high enough to sufficiently cool the lamp 15 and the optical engine 17.

The system controller 10 detects whether or not an image signal is input to the signal input unit 11 (block A3). Upon detecting the image signal inputting to the signal input unit 11 (YES in block A3), the system controller 10 determines whether or not the detected image signal is input via the image input terminal of the previously selected input line (block A4). It should be noted that a user can select in advance a specific image input line, from which an image signal to be projected onto the screen is input, by operating the operation unit 13.

When it is determined that the detected image signal is input via the image input terminal of the selected input line (YES in block A4), the optical engine driver 16 drives the optical engine 17 under the control of the system controller 10, and performs optical modulation corresponding to the input image signal (block A5). A color image corresponding to the input image signal is projected onto the screen with the light emitted from the lamp 15. The flow then returns to block A3.

When no image signal inputting to the signal input unit 11 is detected (NO in block A3), the system controller 10 controls the lamp driver 14 to decrease the power of the lamp 15 so as to decrease the brightness of the light emitted from the lamp (block A6). The predetermined background image (such as blue screen) is projected onto the screen through the optical engine 17 (block A7). The flow then returns to block A3.

Even in the case where the image signal inputting to the signal input unit 11 is detected (YES in block A3), when the image signal is not input from the image input terminal of the selected input line (NO in block A4), the system controller 10 controls the lamp driver 14 to decrease the power of the lamp 15 so as to decrease the brightness of the light emitted from the lamp 15 (block A6). The predetermined background image is projected onto the screen through the optical engine 17 (block A7). The flow then returns to block A3.

In the case where no image signal is input to the signal input unit 11, or in the case where an image signal is input to the signal input unit 11 but the input image signal is not from the selected input line, the predetermined background image is projected onto the screen. In such cases, the power of the lamp 15 need not be kept high to generate light having high brightness. For this reason, in the present embodiment, when no image signal is input to the signal input unit 11 and when the image signal input to the signal input unit 11 is not from the selected input line, the power of the lamp 15 is decreased to suppress heat generation from the lamp 15. Decreasing the power of the lamp 15 can also reduce power consumption.

In order to suppress deterioration of optical components due to a rise in temperature, the cooling capacity of the cooling unit 18 is kept high to sufficiently cool the lamp 15 and the optical engine 17.

Regardless of whether the input image signal is detected or not, the cooling fan of the cooling unit 18 is driven at the predetermined rotational speed to keep the cooling capacity of the cooling unit 18 constant in the present embodiment. However, the rotational speed of the cooling fan may be changed in accordance with a type of the input image signal. Alternatively, the rotational speed of the cooling fan may he changed depending on the power of the lamp 15.

The optical engine 17 may include a temperature sensor. Even in the case where there is no image signal inputting to the signal input unit 11, or in the case where the image signal input to the signal input unit 11 is not from the selected input line, when the temperature detected by the temperature sensor becomes equal to or lower than a predetermined temperature (namely, when the optical engine 17 is sufficiently cooled), the rotational speed of the cooling fan may be decreased. That is, when a sufficient cooling effect is achieved, the cooling capacity of the cooling unit 18 is reduced by decreasing the rotational speed of the cooling fan. Therefore, noise generated by the cooling fan can be reduced.

### SECOND EMBODIMENT

The second embodiment of the present invention will be described next. The same portions as those of the first embodiment will be indicated in the same reference numerals and their detailed description will be omitted.

In the first embodiment, the cooling unit 18 cools both the lamp 15 and the optical engine 17. However, each type of the lamp 15 has a suitable temperature for use. In order to keep a proper temperature condition for the lamp 15, it is preferable to change capacity of cooling the lamp in accordance with a change in lamp power.

FIG. 4 is an exemplary block diagram showing an electric configuration of a projector apparatus according to the second embodiment of the present invention. The projector apparatus according to the present embodiment includes a first cooling unit 18a which cools the lamp 15 and a second cooling unit 18b which cools the optical engine 17. Each of the first and second cooling units 18a and 18b includes a cooling fan and a duct. The system controller 10 can adjust the cooling capacity of the first and second cooling units 18a and 18b by controlling rotational speeds of the cooling fans.

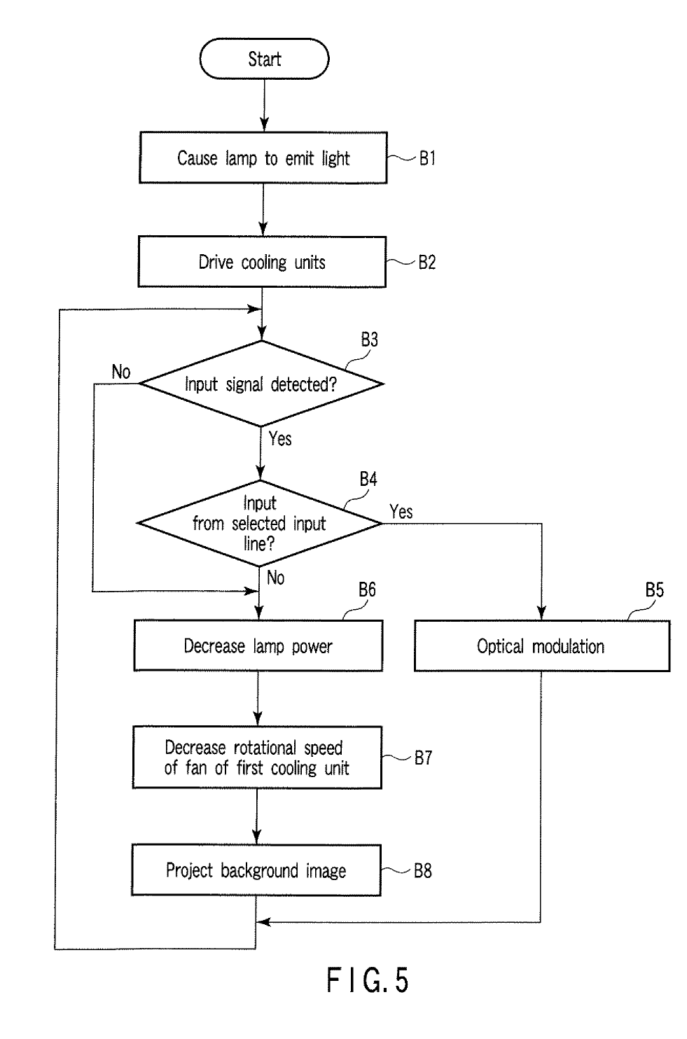

The operation of the projector apparatus having the above configuration according to the second embodiment will be described next. FIG. 5 is an exemplary flowchart showing processing according to the second embodiment of the projector apparatus.

When the projector apparatus starts up, the system controller 10 controls the lamp driver 14 to cause the lamp 15 to start light emission with predetermined brightness (block B1). The lamp 15 emits light with brightness which is appropriate to image projection. The first and second cooling units la and 18b drive the cooling fans at predetermined rotational speeds and start cooling the lamp 15 and the optical engine 17 respectively (block B2). Cooling capacities of the first and second cooling units 18a and 18b (rotational speeds of the cooling fans) are set high enough to sufficiently cool the lamp 15 and the optical engine 17.

The system controller 10 detects whether or not an image signal is input to the signal input unit 11 (block B3). Upon detecting the image signal inputting to the signal input unit 11 (YES in block B3), the system controller 10 determines whether or not the detected image signal is input via the image input terminal of the previously selected input line (block B4). It should be noted that a user can select in advance a specific image input line, from which an image signal to be projected onto the screen is input, by operating the operation unit 13.

When it is determined that the detected image signal is input via the image input terminal of the selected input line (YES in block B4), the optical engine driver 16 drives the optical engine 17 under the control of the system controller 10, and performs optical modulation corresponding to the input image signal (block B5). A color image corresponding to the input image signal is projected onto the screen with the light emitted from the lamp 15. The flow then returns to block B3.

When no image signal inputting to the signal input unit 11 is detected (NO in block B3), the system controller 10 controls the lamp driver 14 to decrease the power of the lamp 15 so as to decrease the brightness of the light emitted from the lamp (block B6).

Even in the case where an image signal inputting to the signal input unit 11 is detected (YES in block B3), when the image signal is not input from the image input terminal of the selected input line (NO in block B4), the system controller 10 controls the lamp driver 14 to decrease the power of the lamp 15 so as to decrease the brightness of the light emitted from the lamp 15 (block B6).

After the power of the lamp 15 is decreased, the system controller 10 decreases the rotational speed of the cooling fan of the first cooling unit 18a which cools the lamp 15 (block B7). That is, the system controller 10 reduces the cooling capacity of the first cooling unit 18a. The optical engine 17 then projects the predetermined background image onto the screen (block B8). The flow then returns to block B3.

In the case where no image signal is input to the signal input unit 11, or in the case where an image signal is input to the signal input unit 11 and the input image signal is not from the selected input line, the predetermined background image is projected onto the screen. In such cases, the power of the lamp 15 need not be kept high to generate light having high brightness. For this reason, in the present embodiment, when no image signal is input to the signal input unit 11 or when the image signal input to the signal input unit 11 is not from the selected input line, the power of the lamp 15 is decreased to suppress heat generation from the lamp 15. Decreasing the power of the lamp 15 can also reduce power consumption.

In addition, in order to suppress deterioration of optical components due to a rise in temperature, the cooling capacity of the second cooling unit 18b is kept high to sufficiently cool the optical engine 17. Therefore, the optical engine 17 can sufficiently be cooled, and deterioration of optical components including organic materials such as polarizing plates 36 and liquid crystal panels 25R, 25G, and 25B can be suppressed.

Regarding the lamp 15, the cooling capacity of the first cooling unit 18a is changed in accordance with a change in lamp power. Accordingly, temperature condition suitable for using the lamp 15 can be maintained. In addition, since the rotational speed of the cooling fan of the first cooling unit 18a is decreased, noise of the projector apparatus can be suppressed.

In the present embodiment, the cooling fan of the second cooling unit 18b is driven at the predetermined rotational speed to keep the cooling capacity of the second cooling unit 18b constant. However, the rotational speed of the cooling fan of the second cooling unit 18b may be changed in accordance with a type of the input image signal. Alternatively, the rotational speed of the cooling fan of the second cooling unit 18b may be changed depending on the power of the lamp 15.

The optical engine 17 may include a temperature sensor. Even in the case where there is no image signal inputting to the signal input unit 11, or in the case where the image signal input to the signal input unit 11 is not from the selected input lines when the temperature detected by the temperature sensor becomes equal to or lower than a predetermined temperature (that is, when the optical engine 17 is sufficiently cooled), the rotational speed of the cooling fan of the second cooling unit 18b may be decreased. That is, when a sufficient cooling effect is achieved, the cooling capacity of the second cooling unit 18b is reduced by decreasing the rotational speed of the cooling fan. Therefore, noise generated by the cooling fan can be reduced.

In the first and second embodiments, the lamp 15 includes an ultra-high pressure mercury lamp. However, other types of lamps may be employed. In addition, the three-LCD projection system is employed as the projection system of the optical engine 17 in the above embodiments; however, other projection systems such as the DLP system and the LCOS system may be utilized.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A projector apparatus comprising:
an input detector configured to detect input of an image signal;
a light source;
a modulator configured to modulate light emitted from the light source;
a cooling unit configured to cool the light source and the modulator;
a power controller configured to control a driving power of the light source in accordance with a result of detection of the image signal by the input detector; and
a projecting unit configured to project the light modulated by the modulator.

2. The projector apparatus according to claim 1, wherein the power controller decreases the driving power of the light source when the input signal is not detected by the input detector.

3. The projector apparatus according to claim 1, wherein the cooling unit maintains predetermined cooling capacity regardless of whether or not the image signal is detected by the input detector.

4. The projector apparatus according to claim 1, wherein
the power controller decreases the driving power of the light source when the input signal is not detected by the input detector; and
the cooling unit maintains a predetermined cooling capacity regardless of whether or not the image signal is detected by the input detector.

5. The projector apparatus according to claim 1, wherein the power controller decreases the driving power of the light source when the image signal input from a predetermined input line is not detected by the input detector.

6. The projector apparatus according to claim 1, further comprising:
input lines from which the image signal is input to the input detector; and
a selection unit configured to select one of the input lines, and wherein
the power controller decreases the driving power of the light source when the image signal input from an input line selected by the selection unit is not detected by the input detector.

7. A projector apparatus comprising:
an input detector configured to detect input of an image signal;
a light source;
a modulator configured to modulate light emitted from the light source;
a first cooling unit configured to cool the light source;
a second cooling unit configured to cool the modulator,
a power controller configured to control a driving power of the light source in accordance with a result of detection of the image signal by the input detector;
a cooling controller configured to control a cooling capacity of the first cooling unit in accordance with a result of detection of the image signal by the input detector; and
a projector configured to project the light modulated by the modulator.

8. The projector apparatus according to claim 7, wherein the power controller decreases the driving power of the light source when the input signal is not detected by the input detector.

9. The projector apparatus according to claim 7, wherein the cooling controller decreases the cooling capacity of the first cooling unit when the input signal is not detected by the input detector.

10. The projector apparatus according to claim 7 wherein the second cooling unit maintains predetermined cooling capacity regardless of whether or not the image signal is detected by the input detector.

11. The projector apparatus according to claim 7, wherein
the power controller decreases the driving power of the light source; and
the cooling controller decreases the cooling capacity of the first cooling unit when the image signal input from a predetermined input line is not detected by the input detector.

12. The projector apparatus according to claim 7, further comprising:
input lines from which the image signal inputs to the input detector; and
a selection unit configured to select one of the input lines, and wherein
the power controller decreases the driving power of the light source; and
the cooling controller decreases the cooling capacity of the first cooling unit when an image signal input from an input line selected by the selection unit is not detected by the input detector.

13. A control method for a projector apparatus which includes a light source, a modulator configured to modulate light emitted from the light source, and a cooling unit configured to cool the light source and the modulator, the method comprising:
detecting input of an image signal;
controlling a driving power of the light source in accordance with a result of detection of the image signal; and
projecting the light modulated by the modulator.

14. A control method for a projector apparatus which includes a light source and a modulator configured to modulate light emitted from the light source, a first cooling unit configured to cool the light source, and a second cooling unit configured to cool the modulator, the method comprising:
detecting input of an image signal;
controlling a driving power of the light source in accordance with a result of detection of the image signal;
controlling a cooling capacity of the first cooling unit in accordance with the result of detection of the image signal; and
projecting the light modulated by the modulator.
